(19) United States
(12) Patent Application Publication
(10) Pub. No.: US 2008/0179310 A1
(43) Pub. Date: Jul. 31, 2008

(54) Electric Arc Furnace Runner and Method of Forming an Expendable Lining of an Electric Arc Furnace Runner

(75) Inventor: Roy Richard Ramey, Forest, VA (US)

Correspondence Address: MINERALS TECHNOLOGIES, INC., 1 HIGHLAND AVENUE, BETHLEHEM, PA, 18017-9482, US

(73) Assignee: Specialty Minerals (Michigan) Inc.

(21) Appl. No.: 12/017,785

(22) Filed: Jan. 22, 2008

Related U.S. Application Data
(60) Provisional application No. 60/897,005, filed on Jan. 22, 2007.

(51) Int. Cl. H05B 7/18; F27D 1/16; C04B 35/14

(52) U.S. Cl. 219/383; 264/30; 501/133

(57) ABSTRACT

The refractory material applied to an electric arc furnace runner is 85 to 95 wt. percent alumina, and 5 to 15 wt. percent aqueous sodium silicate. The heat from molten metal being processed is transmitted to the refractory material of the present invention by contact of the molten metal with the refractory material or by transmission of heat to the refractory material so as to sinter at least a portion of the refractory material and form a solid barrier to the flow of molten metal through the refractory. After the molten metal has been processed and no longer contacts the refractory material, the refractory material can have a portion which is free of water and remains in the form of a powder.

This application claims the benefit of U.S. Provisional Application 60/897,005 filed Jan. 22, 2007 entitled “Refractory Composition and Method of Forming a Lining oil a Refractory Structure” the entire specification of which is incorporated by reference.

### BACKGROUND OF THE INVENTION

The present invention relates to an expendable refractory material for applying to an electric arc furnace runner and a method of applying the refractory material to an electric arc furnace runner. More particularly, the invention is directed to preserving or maintaining electric arc furnace runners or linings for electric arc furnace runners from mechanical erosion, thermal shock, and/or attack by corrosive materials such as those produced during manufacture of ferrous metals or metal alloys including acid and basic slags. The refractory linings also are exposed to thermal shock, which can cause premature failure of the refractory.

### SUMMARY OF THE INVENTION

The present invention is directed to a refractory material for applying to a refractory structure such as an electric arc furnace runner and a method of applying the refractory material in the form of a lining or coating to a refractory structure, particularly a hot refractory structure using the refractory material. The refractory material can be applied to a refractory structure such as an electric arc furnace runner, a tundish, or an electric arc furnace tap hole or a basic oxygen furnace tap hole. The composition applied to the refractory structure comprises 85 to 95 wt. percent of an alumina source, and 5 to 15 wt. percent aqueous sodium silicate.

In another embodiment the composition applied to the refractory structure comprises 85 to 95 wt. percent of an alumina source, and 5 to 13 wt. percent aqueous sodium silicate.

In another embodiment the composition applied to the refractory structure comprises 85 to 95 wt. percent of an alumina source, and 5 to 10 wt. percent aqueous sodium silicate.

The heat from the molten metal being processed is transmitted to the refractory material of the present invention by contact of the molten metal with the refractory material or by transmission of heat to the novel refractory material so as to sinter at least a portion of the refractory material and form a solid barrier to the flow of molten metal through the refractory material. The solid barrier layer can be continuous. After the molten metal has been processed, and no longer contacts the refractory material, the refractory material that formed the expendable lining can have a barrier forming portion, and underneath the barrier portion, a nonself-supporting portion which is free of liquid and/or water and is in the form of a powder after the above described application of heat to the applied refractory material of the present invention.

After at least a portion of the refractory material has been sintered, the layer maintains the refractory lining against attack by corrosive materials such as molten slags and molten metals, especially against attack by acid and basic slags, and steel.

In the method of the invention, application of the blend or admixture can be applied to provide a layer of refractory lining of a thickness of about 0.125 inches to about 2.0 inches in one embodiment and in another embodiment 0.125 inches to about 1.5 inches both prior to exposing as well as after exposing the lining to corrosive materials. When the material is applied to a tundish or a ladle, the dimensions of the applied refractory material in a particular direction can be greater than 2.0 inches. Desirably, application of the refractory material is performed prior to initial exposure of the refractory lining to the corrosive, materials, and can be repeated after each exposure of the lining to those corrosive materials. Depending on the degree of erosion and/or corrosion of the lining formed on the refractory material, or the erosion/corrosion of the refractory material acting as the substrate for the novel material, the refractory material of the present invention need not be reapplied to the refractory material after each run of corrosive materials over the refractory lining.

Application of the refractory material can be performed while the lining material is at a temperature of about 32 degrees F to about 3000 degrees F, preferably about 75 degrees to about 2000 degrees F.

### BRIEF DESCRIPTION OF THE DRAWINGS

FIG. 1 is a perspective view of an electric arc furnace runner;

FIG. 2 is an illustration of the refractory material of the present invention formed on an electric arc furnace runner.

FIGS. 3 and 4 are an illustration of the refractory material lining of the present invention formed on a tundish, and

FIG. 5 is an illustration of the refractory material of the present invention formed on a basic oxygen furnace taphole. FIG. 6 is sectional view taken along the line of 6-6 of FIG. 2

FIG. 7 is a sectional view of an electric arc furnace for providing a ferrous melt from the electric arc furnace to an electric arc furnace runner having the lining of the present invention.

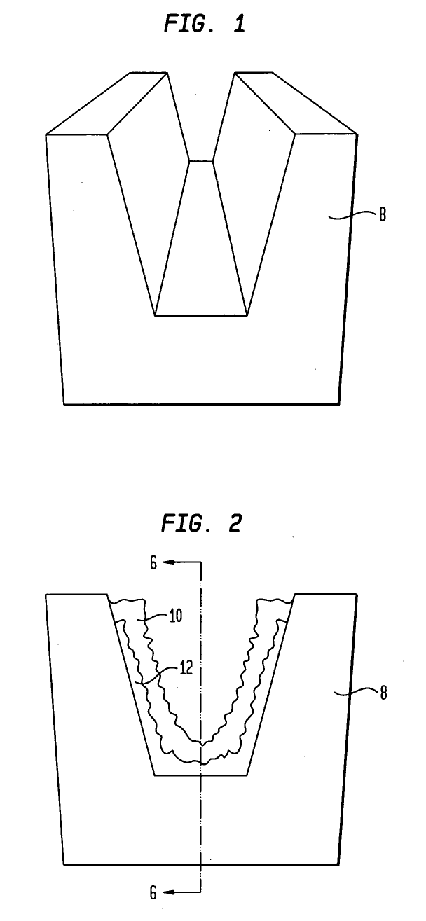

### DETAILED DESCRIPTION OF THE INVENTION

The invention will now be described in detail by reference to the following specification and non-limiting examples. Unless otherwise specified, all percentages are by weight and all temperatures are in degrees Fahrenheit.

FIG. 2 depicts the refractory material of the present invention formed on an electric arc furnace runner 8 showing sintered refractory material which forms an expendable lining 10 which forms a barrier against the erosive and corrosive effects of molten metal and slag. Discontinuous non-sintered powdered material 12 is shown in regions which are not exposed to the flow of molten metal and slag. The runner 8 is a trough that conveys molten steel and slag from an electric arc furnace during tapping to a ladle. The moist powder refractory material of the present invention is placed along the bottom of the runner, then manually spread up the sides and pressed into place. The invention isolates and thus protects the more expensive underlying runner refractory materials from molten steel and slag which are flowing at a high velocity, and are erosive and corrosive in nature. It also extends the life of the runner, hence reducing downtime of the electric arc furnace due to replacement of the runner refractory. A portion of the expendable refractory material of the present invention is washed or eroded away during service, and this can be replaced with new refractory after the tapping of the electric arc furnace.

Upon contact of the ferrous melt of the electric arc furnace with the applied refractory lining on the electric arc furnace runner at least a portion of the refractory lining sinters sufficiently fast that a barrier against erosion and corrosion is formed.

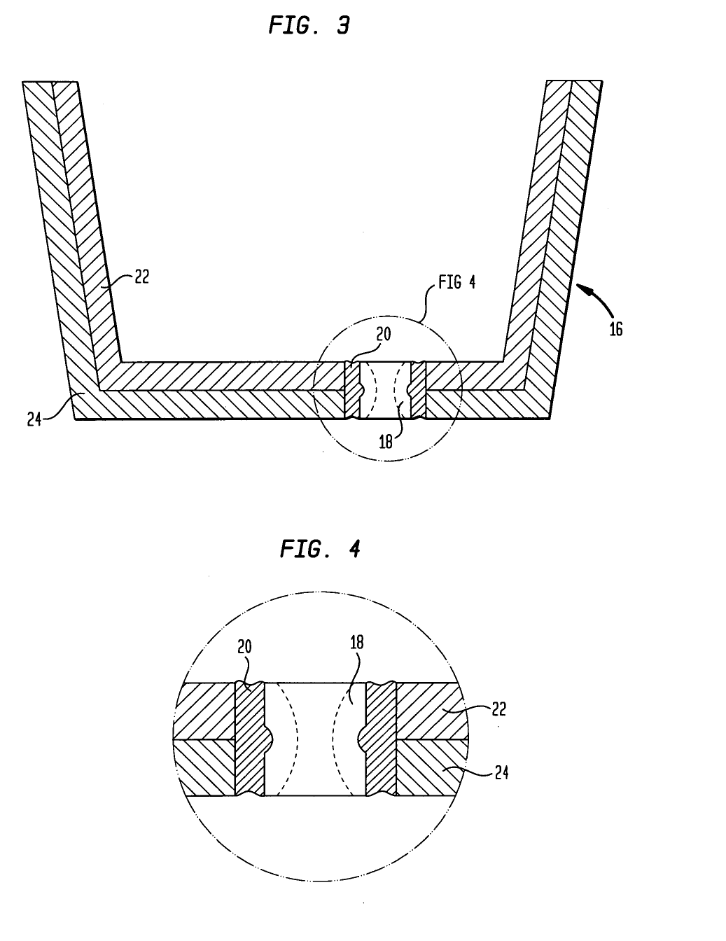

FIGS. 3 and 4 shows the refractory material lining 20 of the present invention formed on a tundish 16 having pocket block 18; the refractory material 20 of the present invention serves to fill in the voids between the relatively permanent working lining 22 and the safety lining 24, and also serves to anchor and stabilize the pocket block 18; and

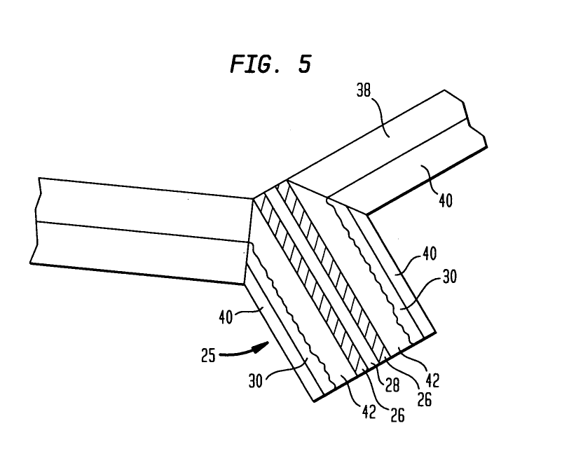

FIG. 5 shows the refractory material of the present invention formed on a basic oxygen furnace taphole 25. The standard taphole 25 opens at opening 28 into the interior of the vessel which has refractory brick 38 and steel shell 40 and surrounding the ceramic sleeve 26 is a sintered refractory structure 42. The ferrous melt exits at opening 28. Nonsintered portion 30 is adjacent to steel shell 40.

FIG. 6 is sectional view taken along the line of 6-6 of FIG. 2 showing expendable lining 10 and discontinuous nonsintered powdered material 12.

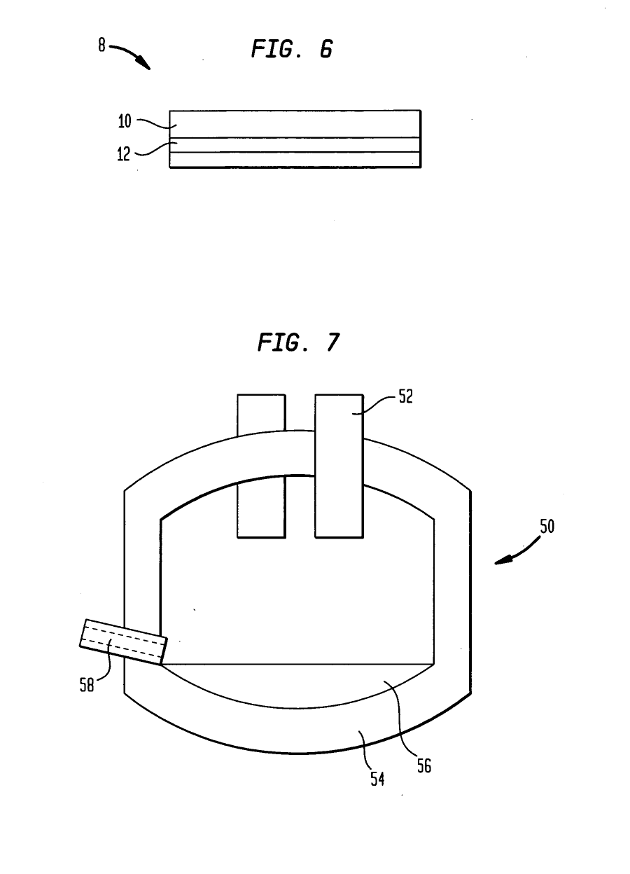

FIG. 7 is a sectional view of an electric arc furnace 50 for providing a ferrous melt 56 from the electric arc furnace 50 to an electric arc furnace runner 8 having the lining of the present invention. The electric arc furnace 50 can have electrodes 52 and furnace refractory lining 54 and a sleeve of ablative material such as a ceramic sleeve 58 at the taphole of the electric arc furnace 50 for providing a means for moving the ferrous melt 56 to the electric arc furnace runner 8. The electric arc furnace 50 can be tilted to provide the ferrous melt 56 to the electric arc furnace runner 8 which sinters at least a portion of the refractory lining of the present invention on the electric arc furnace runner 8.

The electric arc furnace runner 8 can have a means for transporting molten metal such as a monolithic refractory shape or a relatively permanent refractory lining disposed within the transporting means for protecting the electric arc furnace runner against the effects of the molten metal.

The composition applied to the refractory structure comprises 85 to 95 wt. percent alumina, and 5 to 15 wt. percent aqueous sodium silicate. The composition is an alumina based, pre-wetted, fine-sized silicate refractory composition material which can be used as a ramming material by being rammed on a hot surface or a cold surface. The material packs tightly and has good slag and erosion resistance. The material is suitable for use for the maintenance of electric arc furnace runners, around tapholes such as in an electric arc furnace, basic oxygen furnace and around a pocket block at the bottom of a tundish. The refractory material can be applied using conventional ramming methods such as by pneumatic air hammer placement, by tamping, or manually using hand tools or even a wooden block.

In the runner refractory protection application it is believed that the moist powder will set as applied to the underlying relatively permanent refractory layer, and will sinter at temperatures above 1800 degrees F. Typically the refractory material of the present invention will be applied to a hot underlying relatively permanent refractory layer, which is at a temperature of about 200 to 1500 degrees F. Because liquid sodium silicate for the present invention is a combination of Na₂O, SiO₂ and water, the water evaporates upon the application of heat to the applied moist powder refractory material of the present invention and the remaining soda and silica components bond together the dry aggregate. Residual heat from the runner refractory substrate aids the refractory composition of the present invention in setting in place prior to tapping of the electric arc furnace contents, and the refractory composition also sinters in situ when molten metal flows from the electric arc furnace for a period of anywhere from five to fifteen minutes.

In addition to being applied to a tundish as shown in FIG. 3, the refractory composition of the present invention can be applied to a pocket block on a ladle in a manner similar to that shown.

Binders such as sodium silicate, potassium silicate, or any other material that will allow the material to be packed or tamped into place, and will hold the material in place without dusting or flaking until steel comes into contact with it are applicable.

The alumina can be any type of alumina such as fused alumina or tabular alumina. Preferably white fused, gray fused or brown fused aluminas, which are high-density aluminas, can be used. Bauxite can be used as an alumina source.

The bauxite can be any type of bauxite such as South American, Chinese or a blend of calcined bauxites.

The spinel or MgAl₂O₄ used in the examples below can be any suitable natural oxide of magnesium and aluminum or a synthetic spinel such as magnesia—alumina.

The range for liquid sodium silicate to be used in the invention ranges from 5.0 to 15.0 wt. percent in one embodiment, and from 5.0 to 13.0 wt. percent in another embodiment and 5.6 to 9.6 wt. percent in another embodiment and 5.6 to 6.6 in another embodiment. The molar ratio of Na₂O to SiO₂ is 0.3 to 0.6 in one embodiment and 0.4 to 0.6 in another embodiment.

Storage tests of compositions made according to the present invention indicate that they can be stored for months in plastic lined paper bags without degradation of properties.

Without further elaboration, it is believed that one skilled in the art can, using the preceding description, utilize the present invention to its fullest extent. The following embodiments are, therefore, to be construed as merely illustrative, and not limitative of the remainder of the disclosure in any way whatsoever.

The compositions were tested in an electric arc furnace runner. The compositions met or exceeded the performance requirements in the areas of density, strength, drying, resistance to cracking, preheating, molten metal and slag resistance, durability and sequencing requirements. The ability to de-skull the runner refractory substrate lining was found to be good in all locations.

Unless otherwise identified, all mesh sizes are in U.S. Mesh. Liquid sodium silicate is “D” brand aqueous sodium silicate from the PQ Corporation of Valley Forge, Pennsylvania which contains 55.9 wt. percent water which is a 2.0 silica/soda weight ratio sodium silicate. Bauxite was Alpha Star brand calcined bauxite of C-E Minerals Corporation of King of Prussia, Pa. Spinel is Spinel 25 brand fused alumina rich aggregate containing 25 wt. percent MgO of C-E Minerals Corporation of King of Prussia, Pa. As set forth below, mesh sizes shown in a format such as 14×70 mean particles generally smaller than 14 mesh and generally larger than 70 mesh.

### EXAMPLE 1

Table 1 shows a refractory material in the form of a moist powder suitable for applying onto a hot or cold refractory structure such as a permanent lining of an electric arc furnace runner. The following formulation of refractory material was admixed for two and one-half minutes to form a moist powder and the consistency of the admixture or blend was checked to ensure that no lumps were present. The resulting refractory material was applied to the side walls and bottom of a semi-permanent lining of an electric arc furnace runner. Molten steel at about 1600 degrees C was produced and flowed, or was tapped, through the runner and the novel refractory material sintered in place to form a barrier layer in areas which were in direct contact with the flowing molten metal. The refractory material exhibited sufficient resistance to erosion and corrosion so as to last as a barrier for two or three flows or heats of molten metal from the electric arc furnace runner.

TABLE 1

| Material | Description | Wt. Percent |
|---|---|---|
| Brown Fused Alumina | −70 Mesh | 13.20 |
| Brown Fused Alumina | −50 Mesh | 14.70 |
| Bauxite | −35 Mesh | 41.90 |
| Bauxite | −100 Mesh | 23.30 |
| Aqueous Sodium Silicate | SiO₂:Na₂O wt. ratio of 2.0 | 6.10 |
| Water | — | 0.80 |

The optimal particle size distribution which was achieved is 3 percent of particles having a size of +30 mesh (+600 microns), 42 percent +100 mesh (+150 microns), 60 percent +200 mesh (+75 microns) and 29 percent −325 mesh (−45 microns). The wt. percent of water of the admixture or blend was 4.2 wt. percent which is optimal. In another embodiment the wt. percent of water of the admixture or blend is 3.6 wt. percent.

Preferably, the above blend or formulation has a particle size distribution of 0 to 8 percent of particles having a size of +30 mesh, 37 to 47 percent +100 mesh, 55 to 65 percent +200 mesh and 24 to 34 percent −325 mesh. In one embodiment, after mixing the blend is in the form of a moist powder having a moisture content of 3.8 to 4.6 wt. percent. In another embodiment, after mixing the blend is in the form of a moist powder having a moisture content of 3.1 to 4.1 wt. percent

The dry or non-aqueous chemical composition of the blend on an ignited basis was optimally as follows in wt. percent:

| | |
|---|---|
| Al₂O3 | 89.2 |
| SiO₂ | 5.1 |
| TiO₂ | 3.2 |
| Na₂O | 1.3 |
| Fe₂O₃ | 0.8 |
| K₂O | 0.2 |
| CaO | 0.1 |
| MgO | 0.1 |

Preferably, the dry or non-aqueous chemical composition of the blend on an ignited basis in wt. percent is:

| | |
|---|---|
| Al₂O3 | 88.0 to 92.0 |
| SiO₂ | 4.0 to 7.5 |
| TiO₂ | 2.0 to 4.0 |
| Na₂O | 0.6 to 2.6 |
| Fe₂O₃ | 0.6 to 1.0 |
| K₂O | 0.1 to 0.2 |
| CaO | 0.06 to 0.15 |
| MgO | 0.06 to 0.15 |

TABLE 2

| Material | Description | | Wt. Percent |
|---|---|---|---|
| Brown Fused Alumina | 14 × 70 | Mesh | 19.10 |
| Brown Fused Alumina | 28 × 48 | Mesh | 6.70 |
| Bauxite | −35 | Mesh | 17.00 |
| Bauxite | −16 | Mesh | 27.30 |
| Bauxite | −100 | Mesh | 23.50 |

| | | |
|---|---|---|
| Aqueous Sodium Silicate | SiO₂:Na₂O wt. ratio of 2.0 | 5.60 |
| Water | — | 0.80 |

The optimal particle size distribution which was achieved is 8 percent of particles having a size of +18 mesh, 24 percent +30 mesh, 62 percent +100 mesh and 19 percent −325 mesh. The wt. percent of water of the admixture or blend was 3.9 wt. percent which is optimal. In another embodiment, the wt. percent of water of the admixture or blend was 3.5 wt. percent.

In one embodiment, the above blend or formulation has a particle size distribution of 3 to 13 percent of particles having a size of +18 mesh, 19 to 29 percent +30 mesh, 57 to 67 percent +100 mesh and 14 to 24 percent −325 mesh. Preferably, after mixing, the blend is in the form of a moist powder having a moisture content of 3.5 to 4.4 wt. percent. In another embodiment, the blend is in the form of a moist powder having a moisture content of 3.0 to 4.1 wt. percent.

TABLE 3

| Material | Description | | Wt. Percent |
|---|---|---|---|
| Brown Fused Alumina | 14 × 70 | Mesh | 40.30 |
| Brown Fused Alumina | −70 | Mesh | 18.40 |
| Brown Fused Alumina | −50 | Mesh | 16.70 |
| Spinel | −14 | Mesh | 9.80 |
| Spinel | −25 | Mesh | 23.30 |

| | | |
|---|---|---|
| Aqueous Sodium Silicate | SiO₂:Na₂O wt ratio of 2.0 | 5.70 |

The optimal particle size distribution which was achieved is 7 percent of particles having a size of +18 mesh, 21 percent +30 mesh, 36 percent +100 mesh and 26 percent −325 mesh. The wt. percent of water of the admixture or blend was 4.0 wt. percent which is optimal.

Preferably, the above blend or formulation has a particle size distribution of 3 to 11 percent of particles having a size of +18 mesh, 17 to 25 percent +30 mesh, 32 to 40 percent +100 mesh and 22 to 30 percent −325 mesh. Preferably, after mixing, the blend is in the form of a moist powder having a moisture content of 3.5 to 4.4 wt. percent.

Accordingly, it is understood that the above description of the present invention is susceptible to considerable modifications, changes and adaptations by those skilled in the art, and that such modifications, changes and adaptations are intended to be considered within the scope of the present invention, which is set forth by the appended claims.

I claim:

1. A method for providing an expendable refractory lining having corrosive and erosive resistance on an electric arc furnace runner which receives a ferrous melt from an electric arc furnace which comprises:
applying a refractory material comprising 85 to 95 wt. percent of an alumina source and 5 to 15 wt. percent aqueous sodium silicate to the electric arc furnace runner;
contacting the refractory material with the ferrous melt such that at least a portion of the refractory material sinters upon contact with the ferrous melt thereby forming the expendable lining.

2. The method of claim 1 wherein the alumina source is from the group consisting of white fused alumina, grey fused alumina, brown fused alumina, tabular alumina and bauxite.

3. The method of claim 1 wherein the alumina source comprises greater than 90 wt. percent alumina.

4. The method of claim 1 wherein the refractory material has a particle size of generally less than about 14 mesh.

5. The method of claim 1 wherein the sodium silicate is present in an amount of 5.6 to 9.6 wt. percent.

6. The method of claim 1 wherein the refractory material is from 3.1 to 4.1 wt. percent water.

7. The method of claim 1 wherein the refractory material is applied to the electric arc furnace runner in a thickness of about 0.125 inches to about 2.0 inches.

8. An expendable refractory lining on an electric arc furnace runner having resistance to erosive and corrosive materials formed by the method of claim 1.

9. An electric arc furnace runner for handling molten metal comprising a means for transporting molten metal, a relatively permanent refractory lining disposed within the transporting means for protecting the holding means against the effects of the molten metal, and an expendable refractory lining having resistance to erosive and corrosive materials comprising a refractory structure and a lining of refractory material thereon, wherein said expendable lining is formed by the method of claim 1.

10. A method for providing an expendable refractory lining having corrosive and erosive resistance on an electric arc furnace runner which receives a ferrous melt from an electric arc furnace which comprises:
applying a refractory material comprising 50 to 90 wt. percent of an alumina source, 4 to 40 wt. percent spinel, and 5 to 15 wt. percent aqueous sodium silicate to the electric arc furnace runner;
contacting the refractory material with the ferrous melt such that at least a portion of the refractory material sinters upon con tact with the ferrous melt thereby forming the expendable lining.

11. The method of claim 10 wherein the alumina source is from the group consisting of white fused alumina, grey fused alumina, brown fused alumina, tabular alumina and bauxite.

12. The method of claim 10 wherein the alumina source comprises greater than 90 wt. percent alumina.

13. The method of claim 10 wherein the spinel is a natural oxide of magnesium and aluminum.

14. The method of claim 10 wherein the spinel is a synthetic fused magnesia alumina or a synthetic sintered spinel of magnesia alumina.

15. The refractory material of claim 10 wherein the refractory material has a particle size of generally less than about 14 mesh.

16. The method of claim 10 wherein the sodium silicate is present in an amount of 5.6 to 9.6 wt. percent.

17. The method of claim 10 wherein the refractory material is from 3.1 to 4.1 wt. percent water.

18. The method of claim 10 wherein the refractory material is applied to the electric arc furnace runner in a thickness of about 0.125 inches to about 2.0 inches.

19. An expendable refractory lining on an electric arc furnace runner having resistance to erosive and corrosive materials formed by the method of claim 10.

20. An electric arc furnace runner for handling molten metal comprising a means for transporting molten metal, a relatively permanent refractory lining disposed within the transporting means for protecting the holding means against the effects of the molten metal, and an expendable refractory lining having resistance to erosive and corrosive materials comprising a refractory structure and a lining of refractory material thereon, wherein said expendable lining is formed by the method of claim 10.
